(19) United States
(12) Patent Application Publication
(10) Pub. No.: US 2026/0199944 A1
(43) Pub. Date: Jul. 16, 2026

(54) REFRACTORY LINING DESIGN AND SEPARATION VIA DESTRUCTIVE HYDRATION

(71) Applicant: HarbisonWalker International, Inc., Pittsburgh, PA (US)

(72) Inventor: David HARTWICH, Bethel Park, PA (US)

(73) Assignee: HarbisonWalker International, Inc., Pittsburgh, PA (US)

(21) Appl. No.: 19/561,615

(22) Filed: Mar. 10, 2026

Related U.S. Application Data
(63) Continuation-in-part of application No. 17/968,054, filed on Oct. 18, 2022, now Pat. No. 12,595,211.
(60) Provisional application No. 63/296,912, filed on Jan. 6, 2022.

(51) Int. Cl. B09B 3/40; F27D 1/00

(52) U.S. Cl. CPC B09B 3/40; F27D 1/0006

(57) ABSTRACT

A method of recycling refractory components includes constructing a liner for a metallurgical vessel, demolishing the liner to produce a mixture of refractory components of different chemistry types, destructively hydrating the mixture of refractory components to produce components of reduced size, and separating the components of reduced size into at least two groups based on the relative size of the components of reduced size. The liner is formed from at least two different refractory components. The at least two different refractory components are selected based on hydration characteristics of the at least two different refractory components.

### RELATED APPLICATIONS

This application is a Continuation-in-Part of U.S. patent application Ser. No. 17/968,054 filed on Oct. 18, 2022, which claims the benefit of U.S. Provisional Application No. 63/296,912 filed Jan. 6, 2022, the above-referenced documents hereby fully incorporated herein by reference.

### FIELD OF THE INVENTION

The present invention relates generally to refractory linings, and more particularly, to a refractory lining design and method for producing reclaimed low-impurity refractory aggregate from a refractory lining having said design.

### BACKGROUND OF THE INVENTION

Magnesia-Carbon bricks are broadly used for the lining construction of metallurgical vessels, which are used to produce or refine metals, such as steel. Magnesia-Carbon bricks are the dominant linings in basic oxygen furnaces (BOF), electric arc furnaces (EAF), ladle metallurgical furnaces (LMF) and steel teeming or steel transfer ladles. Key useful characteristics of Magnesia-Carbon bricks include high refractoriness and high corrosion resistance against basic, typically calcium rich slags.

After a refractory lining reaches the end of its service life, the lining of the metallurgical vessel is demolished, the metallurgical vessel is cleaned or repaired and subsequently relined with new Magnesia-Carbon brick linings. The demolished lining contains chemical mixtures of high-quality refractory components that act as impurities to one another, and it can be difficult to remove/separate these impurities when recycling the refractory components that formed the lining. The demolished used lining is either disposed or subjected to one of the common reclaiming processes.

It is estimated that the total volume of demolished Magnesia-Carbon linings available is about 3 to 5 lbs. per ton of steel produced. This is a large volume of material that, if not reclaimed and improved, has limited value. Further, since Magnesium Oxide (MgO) hydrates and disintegrates over time, Magnesia-Carbon bricks are not easily recyclable into roadway aggregate or other secondary construction applications in the same way that alumina-containing materials, or other non-hydratable refractory materials or slags, can be recycled. While Magnesia-Carbon bricks can be recycled, all of the known beneficiation methods have significant limitations with regard to the final properties of the reclaimed aggregate, the yield of the useable aggregate, or the high cost of the useable aggregate compared to costs of virgin ingredients used for the production of Magnesia-Carbon brick.

Reclaiming used Magnesia-Carbon bricks from steel applications for use in high quality refractory products is difficult due to the contamination that can arise from a number of factors. One such contamination can be due to different refractory compositions (Alumina-Magnesia-Carbon (AMC) brick, Magnesia-Alumina-Carbon (MAC) brick, Dolomite brick, Non-Magnesia Castables or Shotcretes, Alumina, or Alumina-Silica, or Olivine materials, or Dolomitic based backfill that are used throughout the Steel vessel; and to a highly variable magnesia brick and monolithic compositions in EAF furnaces. An example of this contamination was shown after grinding reclaimed bricks, where samples of reclaimed material averaged 69.5% MgO and 23.2% Al₂O₃, which implies a high amount of AMC brick contamination that disqualifies the reclaimed material from being used as Magnesia-Carbon bats or recycle. Another form of contamination can be due to incompatible backfill adherence and metallurgical slag adherence to the remnant Magnesia-Carbon brick. An example of this contamination was observed in the sorted reclaimed material, where it was found the contamination being 12% from Alumina-Silica containing backup lining and 5% from calcium rich slag. The metal carbides found in many typical Magnesia-Carbon brick, which are the target of reclaim efforts, act as contaminants themselves.

The metal carbides are typically generated during the high temperature service. In this regard, it has been found that the chemistry of the sized and sorted reclaimed material obtained after a passivation process of metal carbides is much lower in Magnesia content than the original refractory products. Other sources of contamination were found to be due to metal adhering to remnant Magnesia-Carbon brick. These contaminants significantly limit the further use of the reclaimed aggregate and excludes the viability for use in any Magnesia-Carbon brick products.

While the foregoing discussion focuses on Magnesia-Carbon and related carbon-bonded refractory products, many metallurgical vessels also include, and many other high-temperature units are constructed from, refractory components that are not carbon-bonded. By way of example, a vessel may include fired (ceramic-bonded) magnesia brick, chemically bonded magnesia brick, dolomitic brick, or bricks composed with the combination of magnesia and dolomitic aggregate, or forsterite bricks based on olivine, or various spinel bricks, such as magnesia-alumina, or alumina-magnesia, or magnesia chrome bricks, or various bricks commonly called aluminosilicate, from the alumina end of the compositional scale, such as high alumina, mullite, super duty and ending with silica bricks on the other end of the compositional scale, or various specialty bricks such as zircon, composed from zircon and various complementary oxides such as alumina and silica, and/or monolithic refractories such as castables, plastics, rams, gunnites, sprays, or shotcretes, similar in compositions to bricks, that are hydraulically bonded (e.g., cement-bonded), chemically bonded, resin-bonded, or combinations thereof. These non-carbon-bonded refractory components are often demolished together with other refractory materials, resulting in mixed tear-out material that is similarly difficult to reclaim into high-value refractory aggregates due to cross-contamination between different chemistry types.

In mixed tear-out streams that include non-carbon-bonded refractory components, separation is complicated by the fact that different chemistries may have different hydration behavior and may degrade differently when exposed to moisture, steam, or water. For example, basic materials such as magnesium oxide-containing components and dolomitic components, or components containing free calcia, also called lime, may hydrate, expand, weaken, and/or disintegrate when exposed to water, steam, or high-humidity conditions, whereas non-basic materials, such as alumina-based castables and fired alumina materials may be substantially less susceptible to destructive hydration under comparable conditions. Similarly other non-basic materials, such as alumina-silicates, zircon based materials, various spinel materials, or forsterite, if absent of reactive basic materials may be substantially less susceptible to destructive hydration under comparable conditions. Accordingly, a method and liner design that intentionally leverages these hydration differences to enable post-service separation would improve recycling yields, reduce impurity levels, and provide defensive protection against design-around efforts.

### SUMMARY OF THE INVENTION

According to an aspect of the invention, a method of recycling refractory components includes constructing a liner for a metallurgical vessel, demolishing the liner to produce a mixture of refractory components of different chemistry types, destructively hydrating the mixture of refractory components to produce components of reduced size, and separating the components of reduced size into at least two groups based on the relative size of the components of reduced size. The liner is formed from at least two different refractory components. The at least two different refractory components are selected based on hydration characteristics of the at least two different refractory components.

According to another aspect of the invention, a method of separating a mixture of used refractory components of different chemistry types is detailed. The used refractory components are obtained from a demolished refractory liner constructed from at least two different refractory components. The at least two different refractory components are selected based on hydration characteristics of the at least two different refractory components. The method includes destructively hydrating one or more of the used refractory components of the mixture of used refractory components and separating, based on size, the destructively hydrated used refractory components from other components of the mixture of used refractory components.

According to an embodiment, the destructively hydrating causes one of the at least two different refractory components to destructively hydrate to a greater extent than another one of the at least two different refractory components.

According to an embodiment, the destructively hydrating includes hydration-induced expansion that produces cracking, spalling, or granular disintegration.

According to an embodiment, the destructively hydrating includes exposing the mixture of refractory components to water, steam, high humidity air, or any combination thereof under controlled conditions of temperature and humidity.

According to an embodiment, the destructively hydrating further includes soaking or wetting the mixture of refractory components and thereafter exposing the soaked or wetted mixture to elevated temperature and elevated humidity to accelerate hydration.

According to an embodiment, the destructively hydrating is performed in a rotary dryer, a fluidized bed dryer, a humidity-controlled batch dryer, or a pressure-controlled autoclave.

According to an embodiment, the separating includes screening the components of reduced size using at least one mesh size.

According to an embodiment, the separating includes air classification of the components of reduced size.

According to an embodiment, one of the at least two different refractory components includes a basic refractory component. Another one of the at least two different refractory components includes a non-basic refractory component.

According to an embodiment, at least one of the at least two different refractory components includes a magnesia-containing refractory component.

According to an embodiment, at least one of the at least two different refractory components includes an alumina-containing refractory component.

According to an embodiment, a first one of the at least two different refractory components includes a basic refractory component. A second one of the at least two different refractory components includes a non-basic refractory component. The destructively hydrating reduces a size of the basic refractory component to a greater extent than a size of the non-basic refractory component.

According to an embodiment, a first one of the at least two different refractory components includes a magnesia-containing refractory component. A second one of the at least two different refractory components includes an alumina-containing refractory component. The destructively hydrating reduces a size of the magnesia-containing refractory component to a greater extent than a size of the alumina-containing refractory component.

According to an embodiment, at least one of the at least two different refractory components includes a dolomitic refractory component.

According to an embodiment, at least one of the at least two different refractory components includes a free lime-containing refractory component.

According to an embodiment, at least one of the at least two different refractory components is ceramic-bonded.

According to an embodiment, at least one of the at least two different refractory components is chemically bonded.

According to an embodiment, at least one of the at least two different refractory components is hydraulically bonded.

According to an embodiment, the at least one hydraulically bonded refractory component is cement-bonded.

According to an embodiment, one of the at least two different refractory components is carbon-bonded. Another one of the at least two different refractory components is non-carbon-bonded.

According to an embodiment, the liner includes a first region formed from a first one of the at least two different refractory components and a second region formed from a second one of the at least two different refractory components. The second one of the at least two different refractory components has different hydration characteristics than the first one of the at least two different refractory components.

In certain embodiments, the present invention may provide one or more advantages over conventional refractory recycling methods.

In certain embodiments, the invention enables separation of mixed refractory tear-out material based on differences in destructive hydration behavior between refractory components, thereby facilitating recovery of distinct aggregate streams from a demolished liner.

In certain embodiments, the invention allows a liner to be intentionally designed using refractory components selected based on hydration characteristics so that, following demolition and destructive hydration, at least one component undergoes greater size reduction than another component, permitting size-based separation.

In certain embodiments, the invention may improve reclamation yield of reusable refractory aggregate by reducing cross-contamination between basic and non-basic materials, or between magnesia-containing and alumina-containing materials, and/or carbon-bonded and non-carbon-bonded materials.

In certain embodiments, the invention may reduce impurity levels in reclaimed non-basic aggregate, thereby enabling reuse in higher-value refractory applications.

In certain embodiments, hydration characteristics may be tuned through liner design, bonding mechanism selection, chemistry selection, and/or additive selection to create a designed hydration contrast between liner regions.

In certain embodiments, the invention permits iterative hydrotreatment and separation to further refine reclaimed aggregate streams.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic diagram of a conventional refractory vessel;

FIG. 2 is a high-level flow diagram illustrating a method of reclaiming refractory components from a demolished refractory vessel in accordance with the invention;

FIG. 3 is a flow chart diagramming the construction of a refractory lining and the reclamation of refractory components from the lining in accordance with the invention; and

FIG. 4 is a flow chart diagramming the destructive hydration of components of demolished refractory lining and the separation of the components from one another in accordance with the invention.

### DETAILED DESCRIPTION OF THE INVENTION

Various aspects of the invention now will be described more fully hereinafter. Such aspects, however, may be embodied in many different forms and should not be construed as limited to the embodiments set forth herein; rather, these embodiments are provided so that this disclosure will be thorough and complete, and will fully convey its scope to those skilled in the art.

In certain embodiments described in U.S. patent application Ser. No. 17/968,054, the invention relates to hydration-enabled separation of carbon-bonded magnesia-containing refractory components. In the present continuation-in-part application, the inventors have further recognized that the principles described in the earlier application may be extended to refractory systems beyond carbon-bonded components, including ceramic-bonded, chemically bonded, hydraulically bonded, and non-basic refractory components. The additional embodiments described herein provide expanded applicability of hydration-based liner design and separation to a broader range of refractory chemistries while retaining the core principle of selecting liner components based on destructive hydration characteristics.

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well-known process operations have not been described in details so as to not unnecessarily obscure the present invention.

As used herein, “refractory component” includes shaped and monolithic refractory materials that may be carbon-bonded, ceramic-bonded, chemically bonded, hydraulically bonded, resin-bonded, pitch-bonded, phosphate-bonded, or combinations thereof. The phrase “selected based on hydration characteristics” means that the components are chosen such that, under a predetermined hydrotreatment, a first component destructively hydrates to a greater degree than a second component, thereby enabling post-demolition separation of the mixture into at least two groups having different chemistry types.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

As used herein, the term “refractory material” refers to inorganic nonmetal materials utilized in various high-temperature equipment, e.g., steel production, other metal production, non-metal production, glass, cement, lime, chemical, gas, energy production and the like. Refractory materials are characterized by a high melting point, and when exposed to high temperatures they retain some of their strength and retain their form.

Referring to FIG. 1, illustrated is an exemplary lining construction for a metallurgical vessel 10 used to produce or refine metals. The lining construction includes a working lining 12 having a barrel region 14, a lower slag line region 16, an upper slag line region 18 and a freeboard region 20. As shown in FIG. 1, the lower slag line region 16 is between the barrel region 14 and the upper slag line region 18, and the upper slag line region 18 is between the lower slag line region 16 and the freeboard region 20. The working lining 12 has a first working lining side 12a and a second working lining side 12b opposite the first working lining side 12a, where the first working lining side 12a faces an inner molten-metal and molten slag holding region 21 of the metallurgical vessel 10. The lining construction further includes a backup lining 22 formed from one or more of Magnesium Oxide-based brick, or Aluminum Oxide-based brick, either burned or resin bonded, or Aluminum Oxide-based brick or monolithic.

The lining construction further includes a bottom lining 24 arranged adjacent to the barrel region 14. The bottom lining 24 is formed, for example, from Aluminum Oxide based refractory and includes a first bottom lining side 24a and a second bottom lining side 24b opposite the first bottom lining side 24a, where the first bottom lining side 24a faces the inner molten-metal holding region 21. A sub-bottom lining 26 is formed, for example, also from Aluminum Oxide based refractory and is disposed under and in contact with the second bottom lining side 24b. As can be seen in FIG. 1, the sub-bottom lining 26 is arranged under the backup lining 22 and working lining 12 such that the sub-bottom lining 26 is in contact with a bottom portion of the barrel region 14 and a bottom portion of the backup lining 22, i.e., the sub-bottom lining 26 supports the working lining 12, the backup lining 22 and the bottom lining 24. Such bottom construction is typically referred as Plug bottom. Alternatively, the bottom lining 24 could be installed over sub-bottom lining 26 after the back-up lining 22 is constructed and prior to the installation of working lining 12. Such bottom construction is referred as Full bottom. Arranged along a top portion of the lining construction is a flange 28 (also referred to as a lip ring), the flange 28 being distal from the bottom lining 24 and adjacent to a top edge surface of the working lining 12 (in particular the freeboard 20) and the backup lining 22. The sub-bottom lining 26 and backup lining 22 are supported by a steel structure 27 that defines the outer dimensions of the vessel.

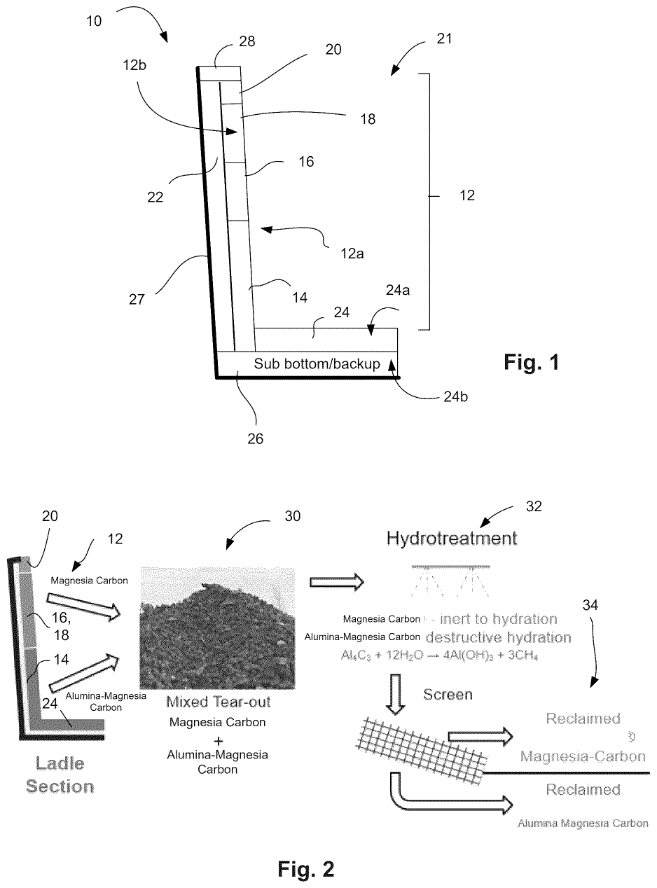

Referring to FIG. 2, a method in accordance with the present invention enables a used working lining 12 of a vessel to be reclaimed without contamination from other refractory sources. In accordance with the invention, the components that form the working lining 12 of the vessel (i.e., the lining that in normal use is in contact with molten metal or molten slag) are specifically selected based on their hydration characteristics. More particularly, the components of the lining are selected such that components from one portion of the lining (e.g., the barrel region 14 and/or bottom lining 24) destructively hydrate to a different degree than another portion of the lining (e.g., the lower and/or upper slag line region 16, 18, the freeboard region 20). For example, the barrel region of the lining may be formed from a carbon-bonded alumina magnesia brick (which does destructively hydrate under the hydrotreatment conditions) and the slag line region may be formed from a carbon-bonded Magnesium Oxide brick (which exhibits substantially less destructive hydration under the hydrotreatment conditions). In other embodiments, at least one of the liner regions may include a non-carbon-bonded refractory component, such as a fired or chemically bonded magnesia-containing refractory component, dolomitic refractory component, or a free lime-containing refractory component, while another region includes a non-basic refractory component such as a fired alumina brick or an alumina-based castable, the selected components exhibiting different destructive hydration characteristics under the hydrotreatment conditions.

The methods described herein are applicable to refractory components irrespective of bonding mechanism. As used herein, “bonded” may include ceramic bonding (e.g., fired brick having sintered grain bonding), chemical bonding (e.g., phosphate, silicate, or other chemical binders), hydraulic bonding (e.g., calcium aluminate cement or other cementitious binders), resin bonding (e.g., phenolic or other organic resins), pitch bonding, or combinations thereof. The term “refractory component” includes shaped refractories (e.g., brick, block, pre-cast shapes) and monolithic refractories (e.g., castables, gunnable mixes, sprays, shotcretes, plastics, rams, and mortars).

The hydration characteristics of a refractory component may be influenced by its chemistry (e.g., basic vs. non-basic), its bonding mechanism, its porosity, grain size distribution, additives, antioxidants, and service history. Accordingly, in certain embodiments, liner regions are selected so that the demolished mixture includes at least one component that undergoes destructive hydration to a greater extent than at least one other component under a defined hydrotreatment, thereby producing a size differentiation sufficient for physical separation.

In certain embodiments, at least one refractory component is selected to undergo destructive hydration by exposure to water, steam, high humidity air, or combinations thereof under controlled conditions of temperature, humidity, pressure, and exposure time. For example, a hydrotreatment may include: (i) soaking or wetting the demolished mixture; (ii) exposing the wetted mixture to elevated temperature and elevated humidity (or steam); and/or (iii) drying while maintaining an oversaturated humidity environment to accelerate hydration and associated degradation of selected phases. In some embodiments, a pressure-controlled autoclave may be used to accelerate hydration of selected refractory phases.

Destructive hydration, as used herein, refers to hydration that causes a mechanical weakening, cracking, spalling, granular disintegration, and/or conversion into smaller pieces or dust, such that the hydrated component experiences a meaningful size reduction relative to its pre-hydration state. In some embodiments, destructive hydration results from volumetric expansion of hydrated phases, including hydroxide formation, which generates internal stresses and crack propagation.

In non-carbon-bonded embodiments, the hydratable refractory component may include, by way of example, magnesia-containing refractory components (including fired magnesia brick, chemically bonded magnesia brick, and magnesia-containing monolithics), dolomitic refractory components, and/or other basic refractory components containing phases that hydrate and expand under the hydrotreatment conditions. The less-hydratable component may include, by way of example, alumina-containing refractory components such as alumina castables, alumina-silica castables, fired alumina brick, or other non-basic refractory components that remain substantially intact under the hydrotreatment conditions.

In certain non-carbon-bonded embodiments, a first liner region may include a fired or chemically bonded magnesia-containing refractory component, or a dolomitic refractory component, and a second liner region may include an alumina-containing refractory component such as a fired alumina brick or an alumina-based castable. Following demolition and hydrotreatment under controlled humidity and temperature conditions, the magnesia-containing and/or dolomitic component may undergo greater destructive hydration and associated size reduction relative to the alumina-containing component. Subsequent screening and/or air classification may thereby separate a magnesia-rich or dolomitic fraction from a relatively intact alumina-rich fraction, enabling recovery of distinct aggregate streams of reduced cross-contamination.

In some embodiments, a liner is intentionally designed such that a first region (e.g., a barrel region) includes a more-hydratable refractory component, and a second region (e.g., a slag-line region, freeboard region, or backup/working interface region) includes a less-hydratable refractory component. After service and demolition, hydrotreatment preferentially reduces the size of the more-hydratable component, permitting screening, air classification, density separation, or combinations thereof to recover separate aggregate streams.

In other embodiments, a liner is intentionally designed such that a first region (e.g., a barrel region) includes a less-hydratable refractory component, and a second region (e.g., a slag-line region, freeboard region, or backup/working interface region) includes a more-hydratable refractory component. Following service and demolition, hydrotreatment preferentially reduces the size of the more-hydratable component irrespective of its original liner position, permitting screening, air classification, density separation, or combinations thereof to recover separate aggregate streams corresponding to the respective liner regions.

In further embodiments, hydration characteristics are adjusted using one or more additives incorporated into one or more refractory components. The additives may be selected to increase susceptibility to destructive hydration, decrease susceptibility to destructive hydration, and/or modify the rate or severity of destructive hydration under the hydrotreatment. Such additives may be used with refractory components of any bonding mechanism, including carbon-bonded, ceramic-bonded, chemically bonded, and hydraulically bonded components, to provide a designed hydration contrast between regions of the liner. For example, a first refractory component may include an additive package that increases destructive hydration under the hydrotreatment, while a second refractory component may include an additive package that decreases destructive hydration and maintains structural integrity under the hydrotreatment.

Examples of additives that decrease susceptibility to destructive hydration include antioxidant and/or hydration inhibitor additives such as silicon metal (Si), boron carbide (B4C), combinations of Si and B4C, aluminum metal (Al), magnesium metal (Mg), magnesium-aluminum alloy or intermetallic (MgAl), and combinations thereof, including additive packages of the types described in Table 1. In some embodiments, such additives reduce moisture ingress, reduce reactive surface area, and/or promote formation of protective phases during service and/or during the hydrotreatment.

Examples of additives that increase susceptibility to destructive hydration include lime (CaO) and/or CaO-containing phases and, in some embodiments, reactive or higher-surface-area magnesia. In some embodiments, increased susceptibility to destructive hydration is achieved by reducing or omitting hydration inhibitors and/or antioxidants in one refractory component relative to another refractory component, thereby increasing the destructive hydration of the component having reduced inhibitor content under the hydrotreatment.

Following hydrotreatment, separation may be performed using one or more of: screening (mesh), air classification, density separation, magnetic separation (to remove metallic contamination), optical sorting, or combinations thereof. In some embodiments, separation is performed iteratively, with a coarse separation after a first hydrotreatment followed by additional hydrotreatment and separation of one or more retained fractions to further improve purity.

Once the lining has reached the end of its service life, the lining is demolished, which produces a mixture of components 30 (e.g., brick components and an easily hydratable slag). The mixture of components 30 is subjected to a hydration process 32 where the components destructively hydrate and break into pieces. In this regard, the components may be processed through a rotary dryer with high humidity to accelerate hydration of hydratable phases present in the demolished mixture, including, in some cases, lime-containing slag phases, thereby causing those hydratable phases to destructively hydrate into dust while relatively less-hydratable refractory components remain in larger fragments. The pieces then can be separated into groups 34 based on size (e.g., brick chunks are separated from hydrated slag dust), where components smaller that a predetermined size may be discarded. The remaining refractory brick chunks may then be soaked in water and again processed through the rotary dryer to accelerate hydration of the hydratable component of the selected region refractory component and preferably cause these brick chunks to destructively hydrate into small aggregates. The components may again be screened to separate un-hydrated brick chunks from hydrated small aggregates.

The hydration and sorting steps may be repeated over several iterations to achieve a good separation of the different components. The components in one or more of the separated groups then can be used to form a new aggregate for refractory materials.

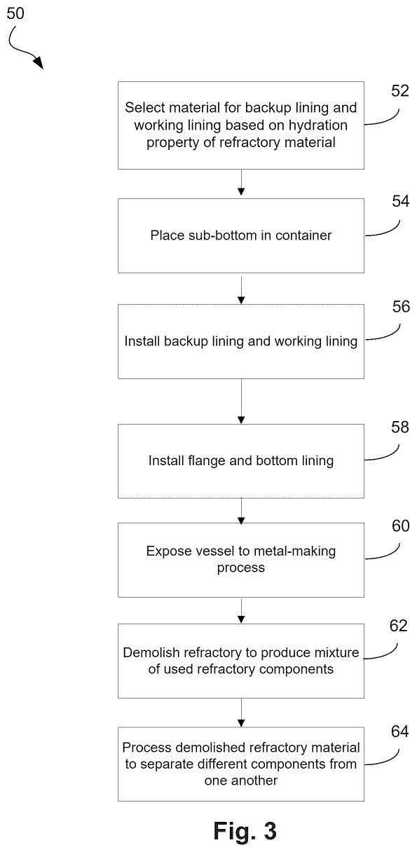

Referring to FIG. 3, illustrated are exemplary steps of a method 50 for constructing a liner of a refractory vessel (e.g., a Steel ladle, EAF furnace, etc.) using at least two different refractory components, where the liner construction facilitates reclamation of refractory material after the liner has reached the end of its service life. Beginning at step 52, components for the working lining (including the barrel region 14, lower slag line 16, upper slag line 18, freeboard region 20) are selected based on hydration characteristics of the components. In this regard, knowledge of what components hydrate more readily and more destructively than others is used to design the liner. For example, the barrel region 14 can be formed from components having a first hydration property, the lower slag region 16 can be formed from components having a second hydration property, and the upper slag region 18 can be formed from components having a third hydration property, where the first, second and third hydration properties are different from each other. The liner regions illustrated in FIGS. 1 and 3 may be formed from refractory components of any bonding mechanism or chemistry type described herein, including carbon-bonded and non-carbon-bonded refractory components.

Table 1 illustrates compositions of additives in order of how hydratable each composition is relative to the other compositions (the top compositions being the most hydratable and the bottom compositions being the least hydratable).

TABLE 1

| | Compositional Additives |
|---|---|
| 1 | Al |
| 2 | Al + Si |
| 3 | Al + B4C |
| 4 | Al + Si + B4C |
| 5 | Al + MgAl + B4C |
| 6 | No metal & No antioxidant |
| 7 | Si |
| 8 | B4C |

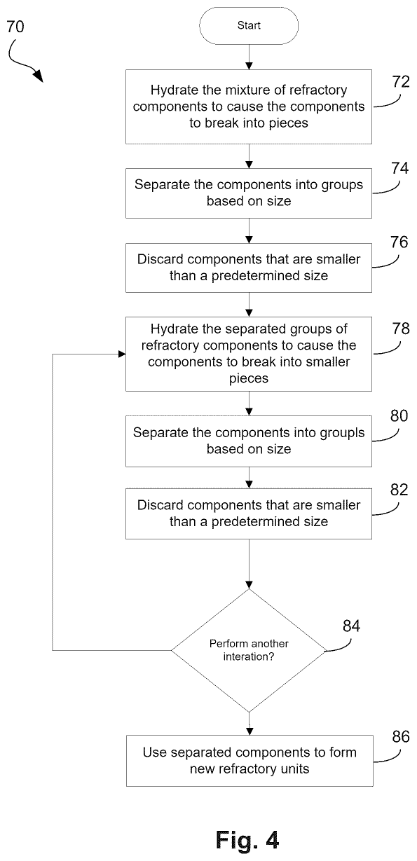

By selecting materials for each lining part and/or each lining region based on hydration properties, the materials can be more-easily separated from one another once the lining has reached the end of its service life and is torn out. More particularly, after lining tear-out a hydrotreatment and screening process is implemented on the mixture of materials to allow for the separation of each material into proper chemical categories. The resulting separated materials are contamination free (low impurity) that can be recycled into high quality refractory products. Further details of the hydration and separation process are discussed below with respect to FIG. 4.

Once the components for each region have been selected, at step 54 the refractory is assembled by placing a sub-bottom 26 within a container structure 27. Next at step 56, a backup lining 22 is arranged within the steel shell 27 of the refractory vessel to define an outer-most surface of the backup lining 22 and a working lining 12 is formed adjacent to the backup lining 22, the working lining 12 then defining an inner-most wall 12a of the metallurgical vessel 10.

Next at step 58 the flange (lip ring) 28 is installed over the backup lining 22 and working lining 12, the flange 28 defining a top surface of the vessel. The flange 28 can be formed from Alumina-based castable or ram. Additionally, the bottom lining 24 is installed over the sub-bottom 26 (i.e., a plug bottom) or over sub-bottom lining 26 after the back-up lining 22 is constructed and prior to the installation of the working lining 12 (i.e., a full bottom).

Next at step 60 the assembled refractory is placed into service, thereby exposing the working lining 12 to a high-temperature process. Once the refractory has reached a point in which it requires repair, the working lining 12 is prepared for tear out and is demolished as indicated at step 62 to produce a mixture of used refractory components of different chemistry types. At step 64 the mixture of components are destructively hydrated to produce components of reduced size, and then separated into groups of components of different sizes, thereby enabling certain desirable components to be reclaimed. Further details concerning the separation process are discussed below with respect to FIG. 4.

Moving now to FIG. 4, illustrated are steps of a method 70 of separating a mixture of used refractory components of different chemistry types obtained from a demolished refractory of the type described herein and specifically to a refectory formed based on the method of FIG. 3. The mixture of components may include at least two of hydratable slag, Dolomite, Magnesia-Carbon, Alumina-Magnesia-Carbon and Magnesia-Alumina-Carbon pieces. Beginning at step 72, the mixture of refractory components are hydrated to destructively hydrate at least some components of the mixture of refractory components into smaller pieces. The components may be hydrated in any one of a number of different methods. For example, the mixture of refractory components may be placed in a dryer at a specified temperature, e.g., 230 degrees F.) with a specified relative humidity, e.g., a relative humidity of at least 17% at dewpoint 150 degrees F. to accelerate hydration of the mixture of refractory components. It is noted that humidity may vary based on the dew point (relative humidity will have a different value at different temperatures and dew points). As such, instead of reference to “relative humidity” another way of considering the hydration parameters is in terms of the oversaturated humidity at set temperature. Alternatively, the mixture of refractory components may be soaked in a liquid, e.g., water, to produce a wet mixture of refractory components. The wet mixture of refractory components then is placed in the dryer to accelerate hydration and cause the wet mixture of refractory components to destructively hydrate into aggregates. The dryer may be any one of a rotary dryer, a fluidized bed dryer, a humidity-controlled batch dryer or humidity or a pressure-controlled autoclave. Acceleration of the hydration process may be targeted at components that include one or more of Aluminum Carbide, Al, Mg, MgAl or Lime.

Upon the components are destructively hydrated, they are separated from one another based on size as indicated at step 74. For example, components larger than a first predetermined size may be placed in a first group, and components smaller than the first predetermined size may be placed in a second group. To separate the components, a screen mesh may be utilized to separate large components from small components. Alternatively or additionally, an air classifier may be utilized to separate the some components from other components. Components smaller that a second predetermined size (i.e., a size smaller than the first predetermined size), such as hydrated slag dust, which may include lime oversaturated calcium aluminate-type slag (e.g., CaO greater than 40% by weight, where a CaO:Al₂O₃ ratio is greater than 0.94 by weight) and/or hydratable phases of calcium aluminates that have been separated from the refractory components, may be discarded, as indicated at step 76.

A second iteration of the hydration and separating steps may be performed to further refine the purity of the respective groups of components. More particularly, at step 78 one or more of the separated groups of components may be again hydrated to destructively hydrate the components into additional components and thus cause the components to break into smaller pieces. As in the previous hydration step, the components may be soaked in a liquid to produce wet components and the wet components placed in the dryer to accelerate hydration and cause the wet components to destructively hydrate into aggregates that are smaller in size than the wet components. Next at step 80 the components are again separated based on size using the aforementioned separation techniques (e.g., screening using a screen mesh or an air classifier), and at step 82 components smaller than a predetermined size are discarded. Steps 78-82 then may be iteratively performed as needed to further refine the components, as indicated at step 84. The components that are not discarded then can be retained for further processing to produce contaminant-free components that can be used to produce new refractory units, as indicated at step 86.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

What is claimed is:

1. A method of recycling refractory components, comprising:
constructing a liner for a metallurgical vessel, the liner formed from at least two different refractory components, the at least two different refractory components being selected based on hydration characteristics of the at least two different refractory components;
demolishing the liner to produce a mixture of refractory components of different chemistry types;
destructively hydrating the mixture of refractory components to produce components of reduced size; and
separating the components of reduced size into at least two groups based on the relative size of the components of reduced size.

2. A method of separating a mixture of used refractory components of different chemistry types, the used refractory components being obtained from a demolished refractory liner constructed from at least two different refractory components, the at least two different refractory components being selected based on hydration characteristics of the at least two different refractory components, the method comprising:
destructively hydrating one or more of the used refractory components of the mixture of used refractory components; and
separating, based on size, the destructively hydrated used refractory components from other components of the mixture of used refractory components.

3. The method of claim 1, wherein the destructively hydrating causes one of the at least two different refractory components to destructively hydrate to a greater extent than another one of the at least two different refractory components.

4. The method of claim 1, wherein the destructively hydrating includes hydration-induced expansion that produces cracking, spalling, or granular disintegration.

5. The method of claim 1, wherein the destructively hydrating comprises exposing the mixture of refractory components to water, steam, high humidity air, or any combination thereof under controlled conditions of temperature and humidity.

6. The method of claim 5, wherein the destructively hydrating further comprises soaking or wetting the mixture of refractory components and thereafter exposing the soaked or wetted mixture to elevated temperature and elevated humidity to accelerate hydration.

7. The method of claim 5, wherein the destructively hydrating is performed in a rotary dryer, a fluidized bed dryer, a humidity-controlled batch dryer, or a pressure-controlled autoclave.

8. The method of claim 1, wherein the separating comprises screening the components of reduced size using at least one mesh size.

9. The method of claim 1, wherein the separating comprises air classification of the components of reduced size.

10. The method of claim 1, wherein one of the at least two different refractory components includes a basic refractory component, and
wherein another one of the at least two different refractory components includes a non-basic refractory component.

11. The method of claim 1, wherein at least one of the at least two different refractory components includes a magnesia-containing refractory component.

12. The method of claim 1, wherein at least one of the at least two different refractory components includes an alumina-containing refractory component.

13. The method of claim 1, wherein a first one of the at least two different refractory components includes a basic refractory component,
wherein a second one of the at least two different refractory components includes a non-basic refractory component, and
wherein the destructively hydrating reduces a size of the basic refractory component to a greater extent than a size of the non-basic refractory component.

14. The method of claim 1, wherein a first one of the at least two different refractory components includes a magnesia-containing refractory component,
wherein a second one of the at least two different refractory components includes an alumina-containing refractory component, and
wherein the destructively hydrating reduces a size of the magnesia-containing refractory component to a greater extent than a size of the alumina-containing refractory component.

15. The method of claim 1, wherein at least one of the at least two different refractory components includes a dolomitic refractory component.

16. The method of claim 1, wherein at least one of the at least two different refractory components includes a free lime-containing refractory component.

17. The method of claim 1, wherein at least one of the at least two different refractory components is ceramic-bonded.

18. The method of claim 1, wherein at least one of the at least two different refractory components is chemically bonded.

19. The method of claim 1, wherein at least one of the at least two different refractory components is hydraulically bonded.

20. The method of claim 19, wherein the at least one hydraulically bonded refractory component is cement-bonded.

21. The method of claim 1, wherein one of the at least two different refractory components is carbon-bonded, and
wherein another one of the at least two different refractory components is non-carbon-bonded.

22. The method of claim 1, wherein the liner includes a first region formed from a first one of the at least two different refractory components and a second region formed from a second one of the at least two different refractory components, and
wherein the second one of the at least two different refractory components has different hydration characteristics than the first one of the at least two different refractory components.
